(19) United States
(12) Patent Application Publication
(10) Pub. No.: US 2004/0085365 A1
(43) Pub. Date: May 6, 2004

(54) Technique for implementing a functionality tree for an air traffic management system

(76) Inventors: Wulf Eggers, Hanau (DE); Richard M. Helfand, Vero Beach, FL (US); Mayer M. Jacobovits, Rockville, MD (US); Rolf B. Kramer, Williamsburg, VA (US); Joerg D. Tessnow, Roedermark (DE)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/285,556

(22) Filed: Nov. 1, 2002

(51) Int. Cl. G09G 5/00

(52) U.S. Cl. 345/853

(57) ABSTRACT

Managing requirements to incorporate technology advances and user requested enhancements to fielded Air Traffic Control (ATC) systems is challenging. Due to the complex interrelationship between the various subsystems of an ATC system, adding new or revising existing operational requirements is complicated. Operational requirements must be translated into system requirements and integrated into all appropriate existing subsystems. A functionality tree (FT) also helps reduce implementation and integration time and costs by catching potential inconsistencies during requirements definition rather than during implementation and testing.

### BACKGROUND OF THE INVENTION

1. Field of the Invention

The invention relates to a computer implemented system and method for organizing and enabling access to interrelated operational requirements for an air traffic control system.

2. Description of Related Art

Relatively complex systems, such as air traffic control systems, typically contain a number of interrelated sub-systems. Adding new sub-systems or revising existing ones can often result in unanticipated consequences. For example, it may be difficult and time consuming to insure that all affected sub-systems are properly updated when a new requirement is implemented.

Another drawback of complex systems, such as air traffic control systems is that it is often difficult to explain the usefulness of a new requirement, its contribution to the overall operational system, or why it must be implemented at a particular point in time. For example, it may be difficult to pinpoint whether, or to what extent, a modification to a requirement contributes to safety, capacity, economy, or a mixture of these attributes.

Another drawback of complex systems, such as air traffic control systems is that they do not provide a single and relatively intuitive interface through which a user may access the assorted components of an air traffic control operational framework. Among other things, the lack of such an interface leads to increased implementation and integration costs and complicates air traffic control requirements management. Other drawbacks may also exist.

### SUMMARY OF THE INVENTION

In order to overcome these and other drawbacks of complex systems there is provided a functionality tree for organizing and enabling access to information. In one embodiment, the functionality tree may comprise a top level graphical user interface that displays an operational framework, a lower level graphical user interface, accessible via hyper-link or other connection with the top level graphical user interface, that displays additional detail of the operational framework. The lower level graphical user interface may further comprise a first indicator to show interdependence of operational functions within the operational framework, a second indicator to show interdependence of technical functions within the operational framework, and a third indicator to show temporal modifications.

According to some embodiments, the first indicator to show interdependence of operational functions may be a predetermined arrangement of items on the lower level graphical user interface. For example, a vertical arrangement of items on the lower level graphical interface may be used to indicate interdependence of operational functions.

According to some embodiments, the second indicator to show interdependence of technical functions within the operational framework may be a predetermined arrangement of items on the lower level graphical user interface. For example, a horizontal arrangement of items on the lower level graphical interface may be used to indicate interdependence of technical functions.

According to some embodiments, the third indicator to show temporal modifications may be a predetermined color scheme for items on the lower level graphical user interface. For example, different colors may be used to indicate different revisions of system requirements.

According to some embodiments of the invention, there is provided a method for organizing and enabling access to interrelated information that may evolve over time. The method may comprise organizing components of a set of operational requirements into a top-level graphical display, wherein the components are organized according to a predetermined scheme of interrelationships. The method may further comprise linking each component to a lower level graphical display comprising a representation for one or more functions of the component, linking selected ones of the representations for one or more functions to a requirements document and providing a temporal indicator indicating changes over time for the components, the representation for one or more functions of the components and the requirements document.

According to some embodiments of the invention, there is provided a computer implemented system for navigating evolving requirements for an air traffic control system. The computer implemented system may comprise a top level graphical user interface that displays components of an air traffic control operational framework, a lower level graphical user interface, linked to at least one of the components on the top level graphical user interface, that displays representations of one or more functions of the linked component, wherein interrelationships between the one or more functions are visually indicated, a requirements document, linked to at least one of the one or more functions, that displays specific requirements for the air traffic control operational framework, and a temporal indicator to show additions or modifications over time for the requirements document, the one or more functions or the components of the air traffic control operational framework.

The present invention will now be described in more detail with reference to exemplary embodiments thereof as shown in the appended drawings. While the present invention is described below with reference to preferred embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### BRIEF DESCRIPTION OF THE DRAWINGS

FIG. 1 is a schematic illustration of an a top level interface showing some operational framework of the FT according to some embodiments of the invention.

FIG. 2 is a schematic illustration of a lower detailed level interface according to some embodiments of the invention.

FIG. 3 is a schematic illustration of a requirements document according to some embodiments of the invention.

FIG. 4 is a schematic representation of a portion of a functionality tree according to some embodiments of the invention.

FIG. 5 is a schematic illustration of an overall system for implementing a functionality tree according to some embodiments of the invention.

### DETAILED DESCRIPTION OF THE INVENTION

In some embodiments the invention, may comprise a computer implemented functionality tree (FT) that enables organization and access to operational requirements for interrelated sub-systems. The FT may be a four-dimensional point-and-click graphical road map to navigate the evolving requirements of an air traffic control (ATC) system. For example, two of the four dimensions may comprise the planar representation of a requirements document, (i.e., top-to-bottom and left-to-right). The third dimension may comprise the dimension rising conceptually off the display (or into the display) and may consist of the graphics sequences till the overarching operational concept is reached. Finally, the fourth dimension may comprise a temporal dimension represented, for example, by color coding each successive system change.

The FT may be characterized as an operational function centric organized hierarchical tree with evident connectivity from high-level operational functions to individual detailed requirements. In some embodiments, the FT may comprise a graphical road map that is laid on top of existing system requirements, specification and training documents. The FT may include point-and-click hyperlinks, or other connections, between levels, functions and requirements that are closely interrelated, thus providing a link between different subsystems of an ATC system.

In some embodiments, a predetermined scheme of visual indicators may be used to illustrate interdependencies within the operational requirements. For example, vertical links may show operational functions that are affected and horizontal links may show which technical functions and definitions are affected. Other schemes may also be used.

The structure around which the FT may be developed is an overarching operational framework of a given ATC system. For example, the Eurocontrol Developed European Convergence and Implementation Program (ECIP), a common and accepted operational framework in the European ATC community, may be used as an operational frame work for the FT. Other operational frameworks may also be used.

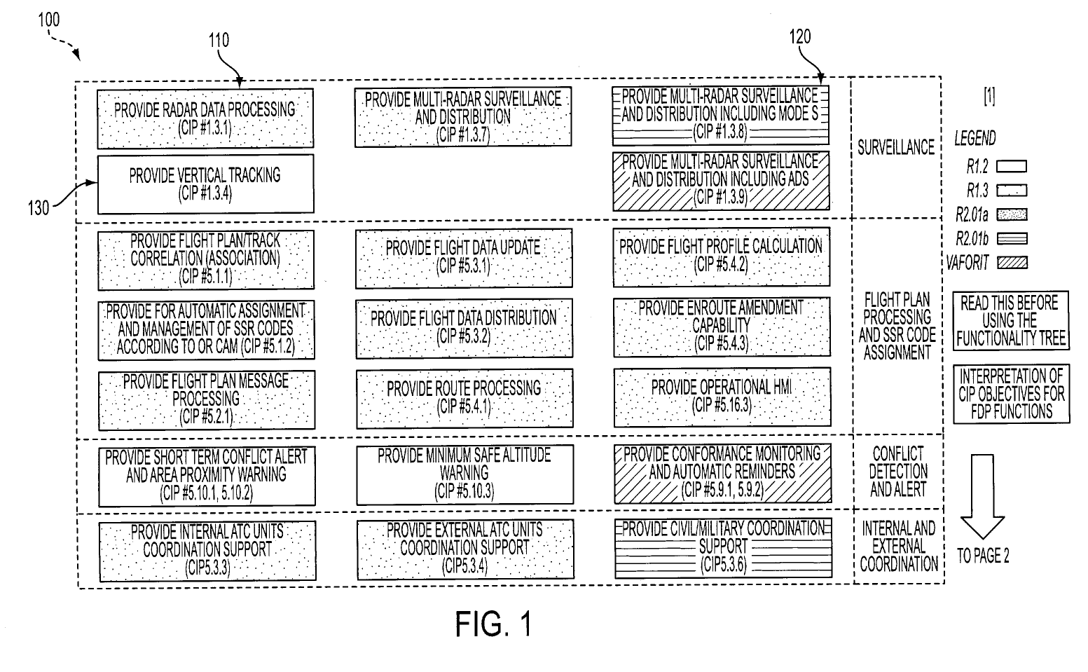

The operational framework may form the top level of the FT. For example, FIG. 1 shows a subset of the ECIP Objectives as a top level 100 of the FT. As shown, each of the top level objectives may comprise a box or other representation in the display. In some embodiments, the boxes may comprise a link or other connection to other portions of the FT. For example, a click on, or any other method of selecting, any of the boxes (e.g., Radar Data Processing Box 110) opens the next lower more detailed level.

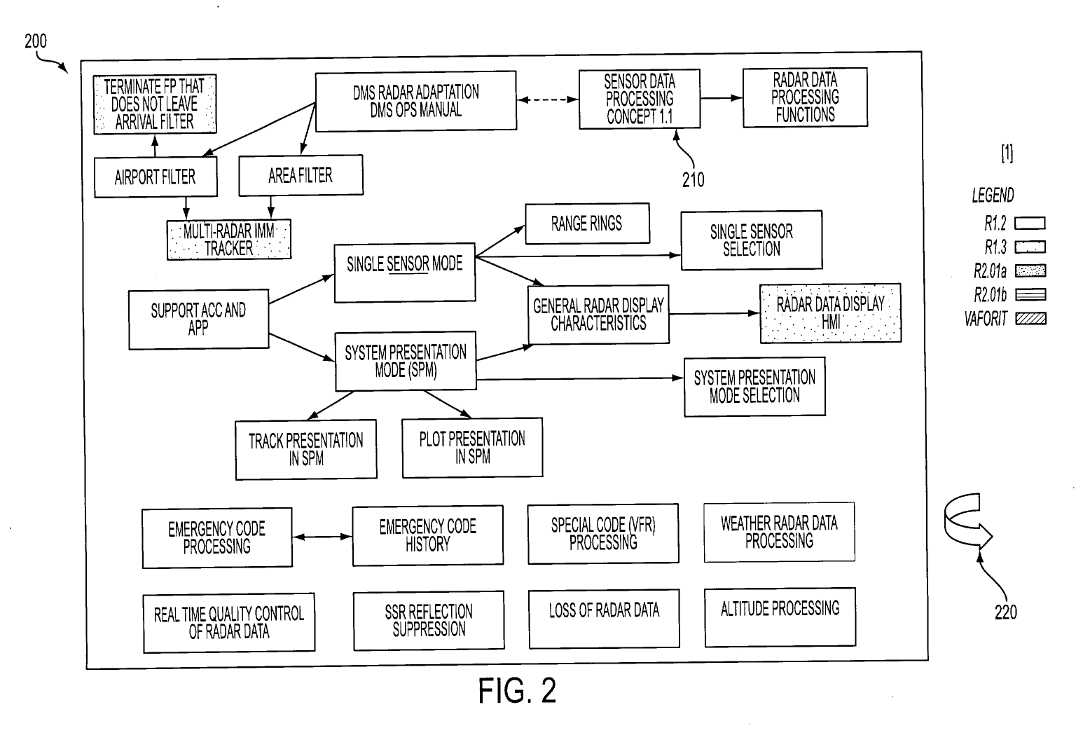

FIG. 2 shows a lower detailed level 200 that may appear with a single click on, or any other method of selecting, a Radar Data Processing Box 110. As shown in FIG. 2, the FT may include a box, or other representation, for each of the major Radar Data Processing functions in an ATC System. Some of the boxes (e.g., Sensor Data Processing Concept Box 210) in FIG. 2 may be hyperlinked to additional lower level charts that further breakdown these major functions into sub-functions.

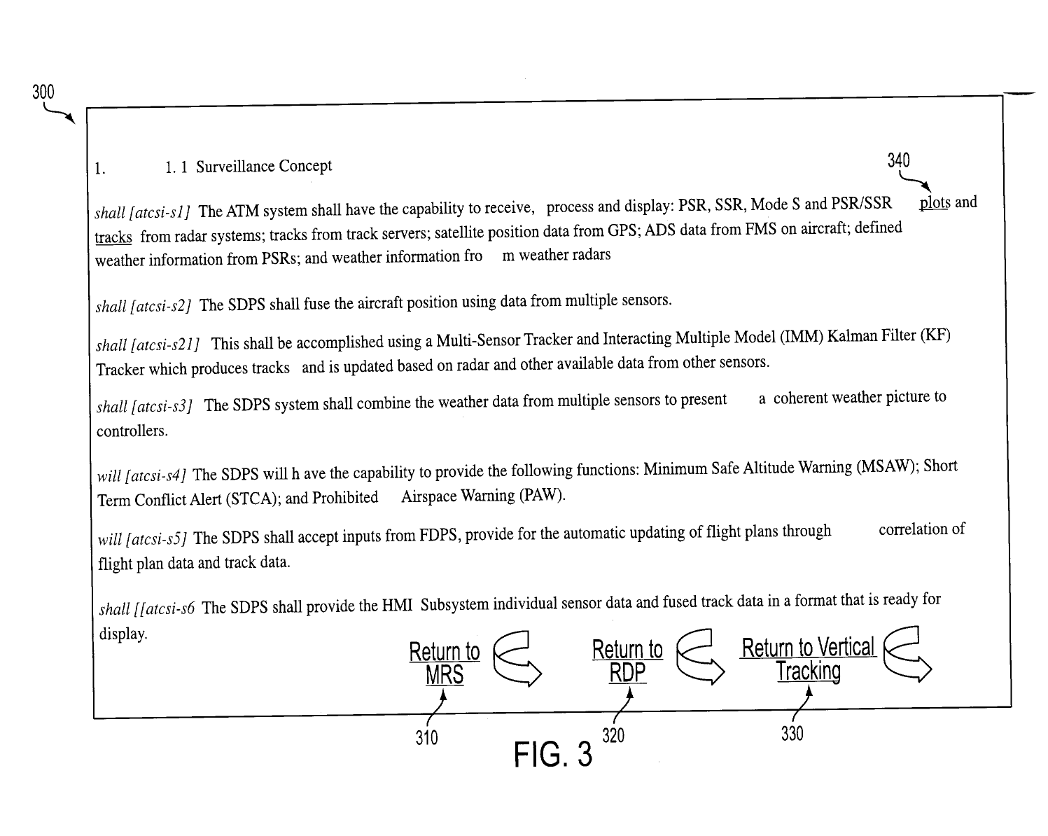

Some of the functions or sub-functions represented on the lower level 200 may be directly hyperlinked to one or more specific system requirements in a requirements document. For example, FIG. 3, shows a requirements document 300 that displays detailed requirements. This requirement document may be opened by a click on the Sensor Data Processing Concept Box 210.

In some embodiments, each lower level and each requirement may have embedded return arrows, or other navigation devices (e.g., 220, 310, 320, 330), to allow a user to navigate around the FT. In some embodiments, it is possible that there are detailed requirements that fulfill requirements of one or more functions or sub-functions. For example, in FIG. 3 three return arrows 310, 320, 330 indicate that three functions (i.e., Multi-Radar Surveillance (MRS) 120, Radar Data Processing (RDP) 110 and Vertical Tracking 130) point to this set of requirements. That is, one could arrive at this set of requirements following different paths from the top level 100 of the FT shown in FIG. 1.

In addition to using the return arrows to navigate back to the level from which the user came, it is also possible to link to one of the other levels a particular related requirement by selecting another return arrow. An example of a horizontal link according to some embodiments is the hyperlinked word track shown at 340 in FIG. 3. Clicking on, or otherwise selecting the word track leads the user to the place in the requirements document where a track is defined.

In some embodiments, hyperlinks or other connections may be designed to function within the same document, across documents to bookmarked text or a picture within another document, or in any other known manner. For example, a horizontal link may also lead a user to another document like a training manual. The user may then access the training manual for any purpose (e.g., to see how a track is displayed on the radar display, etc.).

In some embodiments, a temporal indicator may be used to illustrate evolution of operational requirements over time. For example, different colored boxes, or different patterns (e.g., grey scale or hatchings) in lower level charts may be used for identifying requirements added or modified in different releases over time. Other indicators may also be used. For example, Radar Data Processing box 110 may be a different color or shading than Vertical Tracking 130 to indicate that a modification to the Vertical Tracking operational requirement last occurred at a determinable date. Other schemes for indicating temporal changes are also possible.

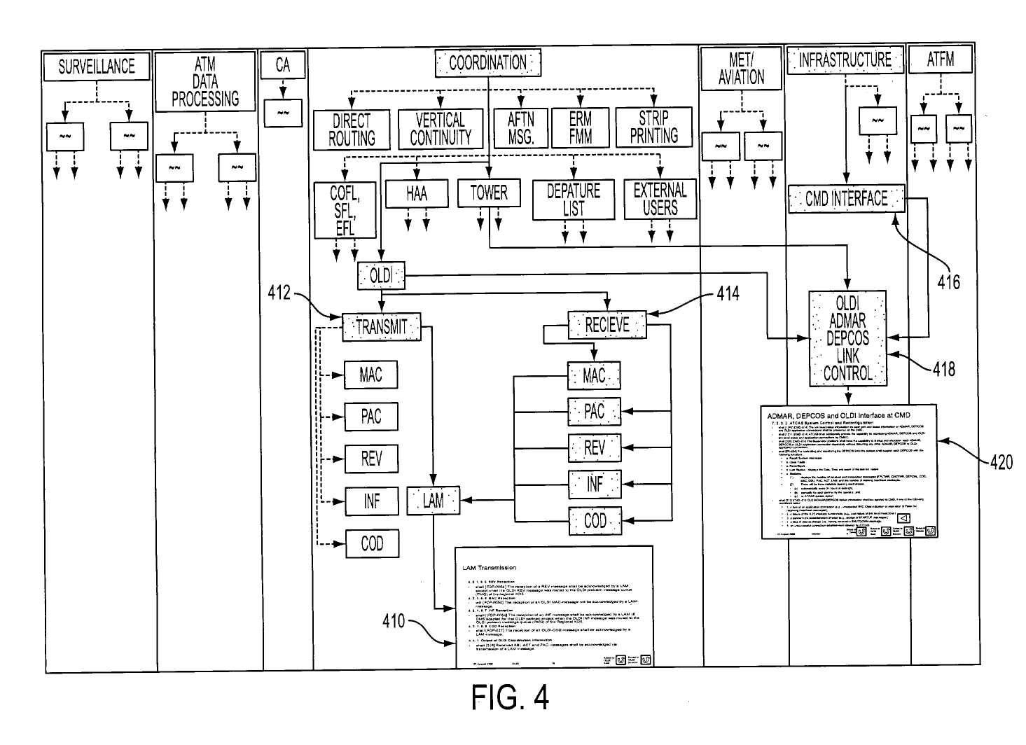

FIG. 4 shows an example of the abundance of information in and the complexity of the FT. Two examples are shown in FIG. 4. In the bottom center of FIG. 4 at 410, is the requirement for generating a Logical Acknowledgment Message (LAM) using the Eurocontrol Standard of On-Line Data Interchange (OLDI). Even though the main level for the LAM requirement document 410 is under the transmission of all OLDI messages as shown at 412, there are also links from 414 to messages received by the system which require the generation of a LAM.

A second example is the requirement to display the status of the various links to the DFS ATC system. There is one Control and Monitor Display (CMD) 416, which displays the link status of OLDI, ADMAR (military) and DEPCOS (Tower) connections 418. Each of these external system connections is described in a different section of the requirements document 420 but the specific requirements about how and when the link status is displayed are described in the CMD section of the document. The FT tree provides the linkage between those requirements for the user.

Another advantage of the FT technique of the present invention is that, through judicious use of hyperlinks among functions required, in-depth and detailed understanding of ATC Systems may be relatively easily obtained. Vertical and horizontal links become a permanent storage of expert knowledge and thought process behind the operational framework. This interconnected structure is conducive to finding inconsistencies among the established requirements, if any exist. It is especially effective in ensuring that appropriate functions in all subsystems are modified as new requirements are added.

Other benefits of the FT technique of the present invention include, but are not limited to the following: 1) providing decision makers a tool to maintain an overview and status of the development stages of the ATC system within the European Convergence and Implementation Programme or other ATC programs; 2) assisting system engineers and operational analysts with integration, and the ability to assess the system-wide impact of new requirements or modifications upon existing requirements; 3) expediting training of incoming system engineers and operational analysts; 4) assisting site personnel with controller training; and 5) providing the ATC organization with a knowledge repository of the experts who have developed the FT.

At this point it should be noted that the technique for implementing a functionality tree in accordance with the present invention as described above typically involves the processing of input data and the generation of output data to some extent. This input data processing and output data generation may be implemented in hardware or software. For example, specific electronic components may be employed in a client-server system, a personal computer (e.g., PC), a laptop, palm top, personal digital assistant (PDA), or similar or related circuitry for implementing the functions associated with a functionality tree in accordance with the present invention as described above.

Alternatively, one or more processors operating in accordance with stored instructions may implement the functions associated with a functionality tree in accordance with the present invention as described above. If such is the case, it is within the scope of the present invention that such instructions may be stored on one or more processor readable carriers (e.g., a magnetic disk, optical storage disk, etc.), or transmitted to one or more processors via one or more signals.

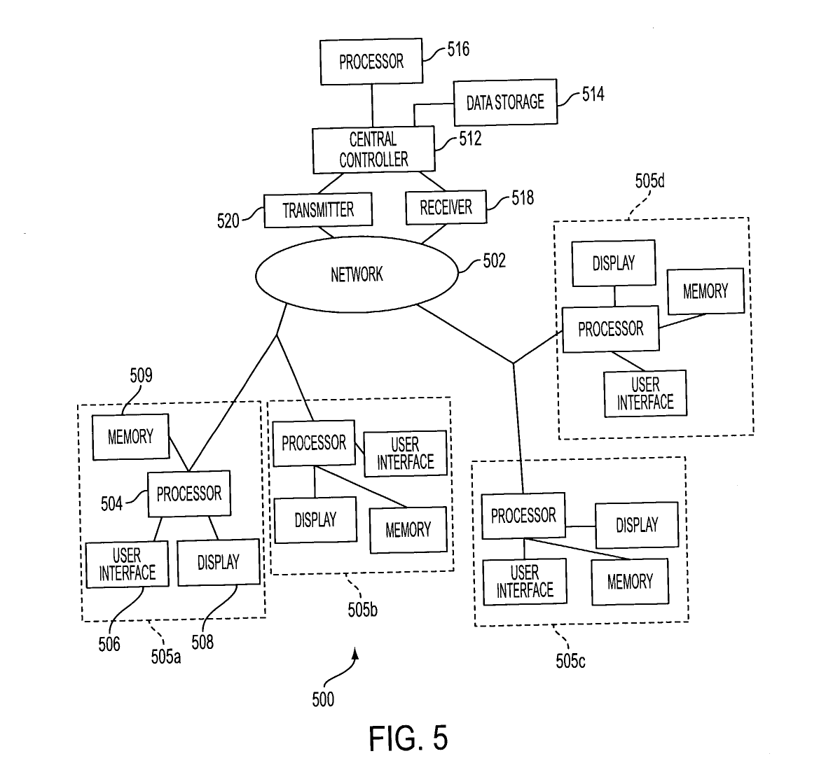

FIG. 5 illustrates a system 500 according to an embodiment of the present invention. The system 500 comprises one or more computer devices 505 (or “computers”). In some embodiments, computers 505 may communicate with a network 502. The network 502 may be any network that permits multiple computers to connect and interact. According to an embodiment of the invention, the network 502 may be comprised of a dedicated line to connect the plurality of the users, such as the Internet, an intranet, a local area network (LAN), a wide area network (WAN), a wireless network, or other type of network.

According to an embodiment of the invention, the computer devices 505a-505d may each make use of any device (e.g., a computer, a wireless telephone, a personal digital assistant, etc.) capable of performing at least some of the functions described above in connection with the FT.

Each of the computers 505a-505d used may contain a processor module 504, a display module 508, a memory 509 and a user interface module 606. Each of the computers 505a-505d may have at least one user interface module 506 for interacting and controlling the computer. The user interface module 506 may be comprised of one or more of a keyboard, a joystick, a touchpad, a mouse, a scanner or any similar device or combination of devices.

Each of the computers 505a-505d may also include a display module 508 and a memory 509. Display modules 508 may comprise a CRT display, LCD screen or other display device. Memory 509 may comprise a hard drive, removable drive storage, other distributed storage device, or the like.

Some embodiments of the invention may be implemented as stand-alone devices. In such embodiments computers 505a-505d may comprise all, or virtually all, of the hardware and software necessary to implement the FT as described above.

Some embodiments of the invention may be implemented in a client-server configuration. In such a configuration, computers 505a-505d may operate as clients to one or more servers such as a central controller module 512. Central controller module 512 may maintain a connection to the network 502 such as through a transmitter module 520 and a receiver module 518. The transmitter module 520 and the receiver module 518 may be comprised of conventional devices that enable the central controller module 512 to interact with the network 502. According to an embodiment of the invention, the transmitter module 520 and the receiver module 518 may be integral with the central controller module 512. According to another embodiment of the invention, the transmitter module 520 and the receiver module 518 may be portions of one connection device. The connection to the network 502 by the central controller module 512 and the computer devices 505 may be a high speed, large bandwidth connection, such as through a T1 or a T3 line, a cable connection, a telephone line connection, a DSL connection, or another similar type of connection. The central controller module 512 may function to permit the computer devices 505a-505d to interact with each other in connection with various applications, messaging services and other services which may be provided through the system 500. The central controller module 512 may comprises either a single server computer or a plurality of server computers configured to appear to the computer devices 505a-505d as a single resource.

A processor module 516 may be responsible for carrying out some processing within the system 500. According to an embodiment of the invention, the processor module 518 may handle high-level processing, and may comprise a math co-processor or other processing devices.

Some data may be stored in a data storage module 514. For example, data storage module 514 stores a plurality of digital files. According to an embodiment of the invention, a plurality of data storage modules 514 may be used and located on one or more data storage devices, where the data storage devices are combined or separate from the controller module 512. One or more data storage modules 514 may also be used to archive information. Other systems may also be used.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

What is claimed is:

1. A functionality tree for organizing and enabling access to information, the functionality tree comprising:
a top level graphical user interface that displays an operational framework; and
a lower level graphical user interface, accessible via a link with the top level graphical user interface, that displays additional detail of the operational framework; and wherein
the lower level graphical user interface comprises:
a first indicator to show interdependence of operational functions within the operational framework;
a second indicator to show interdependence of technical functions within the operational framework; and
a third indicator to show temporal modifications.

2. The functionality tree of claim 1 wherein the first indicator is a predetermined arrangement of items on the lower level graphical user interface.

3. The functionality tree of claim 2 wherein the predetermined arrangement of items on the lower level graphical user interface is a vertical arrangement.

4. The functionality tree of claim 1 wherein the second indicator is a predetermined arrangement of items on the lower level graphical user interface.

5. The functionality tree of claim 4 wherein the predetermined arrangement of items on the lower level graphical user interface is a horizontal arrangement.

6. The functionality tree of claim 1 wherein the third indicator is a predetermined color scheme for items on the lower level graphical user interface.

7. The functionality tree of claim 1 wherein the operational framework relates to an air traffic control system.

8. A method for organizing and enabling access to interrelated information that may evolve over time, the method comprising:
organizing components of a set of operational requirements into a toplevel graphical display, wherein the components are organized according to a predetermined scheme of interrelationships;
linking each component to a lower level graphical display comprising a representation for one or more functions of the component;
linking selected ones of the representations for one or more functions to a requirements document; and
providing a temporal indicator indicating changes over time for the components, the representation for one or more functions of the components, and the requirements document.

9. The method of claim 8 wherein organizing the components according to a predetermined scheme of interrelationships further comprises:
organizing operational functions according to a vertical scheme; and
organizing technical functions according to a horizontal scheme.

10. The method of claim 8 wherein providing a temporal indicator further comprises:
implementing a color code to indicate changes over time for the components, the representation for one or more functions of the components, and the requirements document.

11. The method of claim 8 wherein the set of operational requirements relate to an air traffic control system.

12. A computer implemented system for navigating evolving requirements for an air traffic control system, the computer implemented system comprising:
a top level graphical user interface that displays components of an air traffic control operational framework;
a lower level graphical user interface, linked to at least one of the components on the top level graphical user interface, that displays representations of one or more functions of the linked component, wherein interrelationships between the one or more functions are visually indicated;
a requirements document, linked to at least one of the one or more functions, that displays specific requirements for the air traffic control operational framework;
a temporal indicator to show additions or modifications over time for the requirements document, the one or more functions or the components of the air traffic control operational framework.
